(19) United States
(12) Patent Application Publication
(10) Pub. No.: US 2006/0046308 A1
(43) Pub. Date: Mar. 2, 2006

(54) Method of reaction utilizing microchannel

(75) Inventors: Kenichi Yamashita, Tosu-shi (JP); Hideaki Maeda, Tosu-shi (JP); Hajime Shimizu, Tosu-shi (JP); Masaya Miyazaki, Tosu-shi (JP); Hiroyuki Nakamura, Tosu-shi (JP); Yoshiko Yamaguchi, Tosu-shi (JP)

Correspondence Address: WENDEROTH, LIND & PONACK, L.L.P., 2033 K STREET N. W., SUITE 800, WASHINGTON, DC, 20006-1021, US

(73) Assignee: NATIONAL INSTITUTE OF ADVANCED INDUSTRIAL SCIENCE, TOKYO (JP)

(21) Appl. No.: 10/527,987

(22) PCT Filed: Sep. 24, 2003
(86) PCT No.: PCT/JP03/12172

§ 371 Date: Mar. 21, 2005

(30) Foreign Application Priority Data
Sep. 24, 2002 (JP) 2002-277954

(51) Int. Cl. B01J 19/00

(52) U.S. Cl. 436/180

(57) ABSTRACT

A method of chemically reacting two or more reactants which react one another, which comprises fixing molecules of the reactants to fluids and supplying them to a microchannel to efficiently conduct the chemical reaction based on the molecular structure or molecular orientation imparted to the microchannel or on the function of changing the distributed state of molecules in a solution.

### TECHNOLOGICAL FIELD

The present invention relates to a novel method for carrying out a reaction by utilizing a micro flow channel by which a variety of chemical reactions are carried out efficiently by utilizing the characteristic performance of a micro flow channel to molecules of the compounds as carried by a fluid.

### BACKGROUND TECHNOLOGY

Almost all of the living commodities and base materials thereof, which are daily at our hands, are those by chemical syntheses.

And, in the manufacturing industries of these commodities and base materials, it is very desirable to efficiently carry out the chemical reaction not only in respect of cost reduction for the base materials but also in respect of decreasing the energy consumption and industrial wastes accompanying the production.

In connection with the manufacturing method of the commodities and base materials, it has been the case heretofore that mass production is conducted by a method to carry out the reaction in a batch-wise manner utilizing a large-capacity reactor or to carry out the reaction continuously by passing through a large tube.

While these manufacturing methods of commodities and base materials are suitable for mass production, they are not suitable to a multi-purpose small-lot production mode in which a number of kinds are produced to comply with the desire each in a small amount and, in addition, they have a defect that these manufacturing methods cannot be employed for certain kinds of products.

On the other hand, a method to carry out various reactions, which utilizes a micro flow channel, was developed recently and proposals were made, for example, for a method to carry out an enzymatic reaction with high efficiency in which the enzyme is immobilized onto the wall surfaces by utilizing the fact that the contacting specific surface area with the wall surfaces is large in an extra-fine tubular flow channel [“Chemistry Letters”, 2001, pages 442-443], a method for the preparation of particles of nano-size level uniformity by concurrent introduction of a plurality of solutions to form laminar flows followed by a reaction carried out on the interface between the solutions [an article in “Nikkan Kogyo Shimbun”, Mar. 20, 2002 issue] and the like.

### DISCLOSURE OF THE INVENTION

The present invention has been completed with an object to efficiently carry out a chemical reaction by utilizing the characteristic interaction which a micro flow channel exhibits for molecules carried by a fluid.

The inventors have continued extensive investigations with regard to a chemical method by utilizing a micro flow channel and, as a result, have arrived at a discovery that, by utilizing the characteristic performance of a micro flow channel, the chemical reaction which can hardly proceed in conventional methods proceeds with efficiency leading to completion of the present invention on the base of this discovery.

Namely, the present invention provides a method for carrying out a reaction by utilizing a micro flow channel characterized in that, in carrying out a chemical reaction of two kinds or more of reactants capable of reacting each with the others, molecules of the reactants as carried by a fluid are introduced into a micro flow channel and the chemical reaction is carried out efficiently by utilizing the interactions of the micro flow channel to cause changes in the molecular structure, molecular orientation or distribution of the molecules in the solution.

Thus, the method of the present invention is a method for carrying out a chemical reaction with high efficiency by utilizing the fact that, when a fluid carrying molecules is passed through an extra-fine flow channel having a width not exceeding several hundreds μm, characteristic interactions are exhibited originating in the flowing phenomenon that the flow forms laminar flows or the flow velocity gradient is increased due to the large contacting specific surface area with the wall surfaces, resulting in utilization of a change in the molecular configuration such that, for example, from a condensed rounded state of long straight-chain molecules is extended into an extended state enabling the reaction to a specified reaction site having been hidden inside or the fact that the molecular arrangement is oriented into a specified direction or the molecules of the reactants cause spontaneous gathering to the center portion of the flow channel or to the vicinity of the wall surfaces depending on the conditions.

### BRIEF DESCRIPTION OF THE DRAWING

FIGS. 1 are microscopic photographs showing the results of Example 1.

FIG. 2 is a bar chart showing the results of Example 2.

FIG. 3 is a confocal laser scanning microscopic photograph showing the result of Example 3.

### BEST MODE FOR CARRYING OUT THE INVENTION

It is necessary that the micro flow channel used in the method of the present invention is provided on a substrate consisting of a non-reactive material. The non-reactive material implied here is a material, which exhibits no reactivity to the probe molecules, the specimen molecules, the solvents to be used and the complex to be formed, as exemplified, for example, by glass, quartz or silica, Si/SiO₂, magnesia, zirconia, alumina, apatite, silicon nitride and oxides of metals including titanium, aluminum, yttrium and tungsten as well as ceramics including carbides, nitrides, borides, silicides and the like.

In addition, any metals, plastics and the like can also be used as a substrate provided that they are non-reactive with the reactants to be used. With respect to the form of this substrate, it can usually be a plate but, if so desired, those having an arch-wise form, spherical form, granular form and others can be used.

These materials can be properly selected depending on the means for selection, types of the reactants and the solvents but, when detection is conducted by an optical means, it is necessary to use one which exhibits sufficient transparency to the wavelength of the light used for the detecting part.

The micro flow channel in the present invention is a substrate consisting of these non-reactive materials having been engraved in a size of 1 to 1000 μm or, preferably 50 to 400 μm width and depth, or a capillary tube having a comparable size. The length of this micro flow channel is, though not particularly limited, selected in the range, usually, of 100 to 1000 mm depending on the size of the non-reactive member to be used.

Such a micro flow channel can be a commercial capillary tube used as such or can be prepared by engraving, on a substrate, by a mechanical means using a machine tool such as a microdrill or, alternatively, by the photolithographic technology used in the manufacture of semiconductor integrated circuits and others to form a groove followed by adhesive bonding of another substrate thereto. The fluids passing such an extra-fine flow channel are never mixed together even if the solvents are soluble each to the other to continue flowing as forming laminar flows. Further, such an extra-fine flow channel has characteristics that the distance of diffusion of a substance is short, the contacting specific surface area with the wall surfaces is large, flowing velocity gradient is large and so on.

The specific interactions of the micro flow channel, as used in the inventive method, to the molecules carried by a fluid are exemplified by those in which, for example, when each of the fluids individually carrying the molecules of two different kinds of reactants are concurrently passed through a micro flow channel, a chemical reaction proceeds at the interface; molecules of a compound having a long chain-formed or branched structure in an entangled condition by condensing in a solution are stretched into a straight condition; molecules of the compound dispersed in a randomized condition within the solution are brought into an oriented condition; molecules of the reactants are gathered to the core portion or to the vicinity of the wall surfaces of the flow channel; and others.

In the method of the present invention, a chemical reaction can be rendered to be of high performance by way of the changes in the condition of the reactant molecules brought about by the aforementioned specificity of the condition of the solutions flowing through a micro flow channel. For example, molecules of a DNA or other elongated straight-chain polymeric molecules usually take a condensed state or, namely, a rounded state in a solution but, when flowing through a micro flow channel, they become disentangled and extended to take a linear state. By means of such a change in the configuration of the polymeric molecules, the reaction sites having been in a hidden state can be exposed to the solution resulting in accomplishment of a much greater reaction velocity of a reaction than in the prior art methods or high selectivity of the reaction to specified reaction sites or enablement of an application to a sensing device based on a chemical reaction or recognition of molecules which heretofore was impossible.

While living body-related compounds such as proteins become bonded with high selectivity to a specific objective, an importance is known there of the “induced fit” in which, apart from “keys and keyholes”, the steric configuration of a protein and the like is varied to be in matching with the objective. When such a living body-related substance is passed through a micro flow channel, in addition, the protein becomes to assume a steric structure favorable to recognize the substrate by means of the external factors brought about by the specificity of the flowing condition.

Furthermore, the reactant molecules flowing through a micro flow channel take an oriented state with direction alignment in a specified direction by means of the specificity of the flowing state thereof. Such a state of orientation is necessarily brought about unless the reactant molecules take a completely spherical form. In the case of a reaction at the interface between two solutions, for example, this orientation enables alignment of the reaction sites toward the direction of the interface so that the chemical reaction can be conducted with an increased efficiency.

In the method of the present invention, the solution can be introduced to the micro flow channel, for example, by connecting an injector and by controlling the liquid-supply rate, liquid-supply pressure and the like by a mechanical means such as a syringe pump and the like so as to enable controlling of the structural state and the orientational state of the reactant molecules.

In the method of the present invention, introduction of the reactant molecules to a micro flow channel can be undertaken by mixing two kinds or more of the reactants in advance and introducing a fluid carrying the same, by introducing two kinds or more of fluids carrying the reactant molecules concurrently or immobilizing at least one kind of reactant molecules on the wall surface of a micro flow channel followed by introduction of a fluid carrying reactant molecules differing therefrom.

While the present invention is applicable to chemical reactions in general, it is particularly useful for the syntheses, analyses and isolations of medicines and living body-related substances of which diversity of the product species each in a small lot and with high purities are highly essential.

In the following, the present invention is described in more details by way of examples although the present invention is never limited by these examples in any way.

### EXAMPLE 1

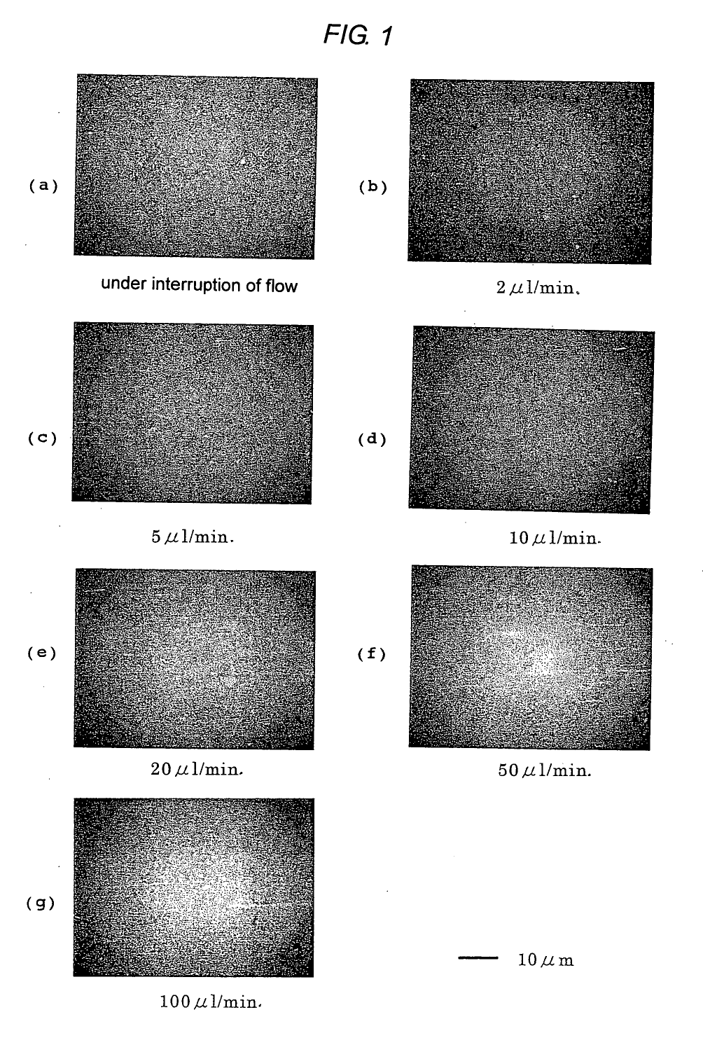

A solution of DNA (T4GT7 DNA) stained with a fluorescent dye, DAPI (4′,6-diamino-2-phenylindole), was introduced into a glass-made capillary having an inner diameter of 500 μm to observe the profiles of the DNA passing the inside under a fluorescence microscope. This solution used was an aqueous solution containing 10 μmol/l of the DNA (calculated for the base pairs), 50 μmol/l of DAPI and 4% (volume ratio) of 2-mercaptoethanol. In the observation conducted from below of the capillary tube, the profiles of the DNA were taken in photos by focusing the microscope at a position 10 μm high from the lower end of the inner wall. FIGS. 1(a) to (g) are the photos showing the profiles of the DNAs under different flow rates. In these figures, (a) is for interruption of flowing and (b), (c), (d), (e), (f) and (g) are for the liquid introducing rates of 2, 5, 10, 20, 50 and 100 μl/minute, respectively.

In these figures, the white spots correspond to the DNA. As is understood from these figures in a series, the observation indicates that the DNAs having been in a condensed state become linearly elongated and they are oriented in the direction of the flow when the flow rate is gradually increased starting from interruption of the flow.

This result leads to an understanding that changes are brought about in the structure of the molecules and further those molecules are oriented in a single direction owing to the specificity of the flowing state of the solution flowing through the micro flow channel.

### EXAMPLE 2

A reducing reaction of pyruvic acid to L-lactic acid by L-lactic acid dehydrogenase was carried out using a batch-wise reactor and a micro flow channel and a comparison was made of the performance. Namely, the reaction was carried out for 4 minutes under the condition of 33 μmol/l of pyruvic acid, 2 μmol/l of L-lactic acid dehydrogenase and a pH 7.4 with a phosphate buffer solution to obtain the yield from the decrease in the absorbance at the maximum absorption wavelength 340 nm of the L-lactic acid dehydrogenase before the reaction.

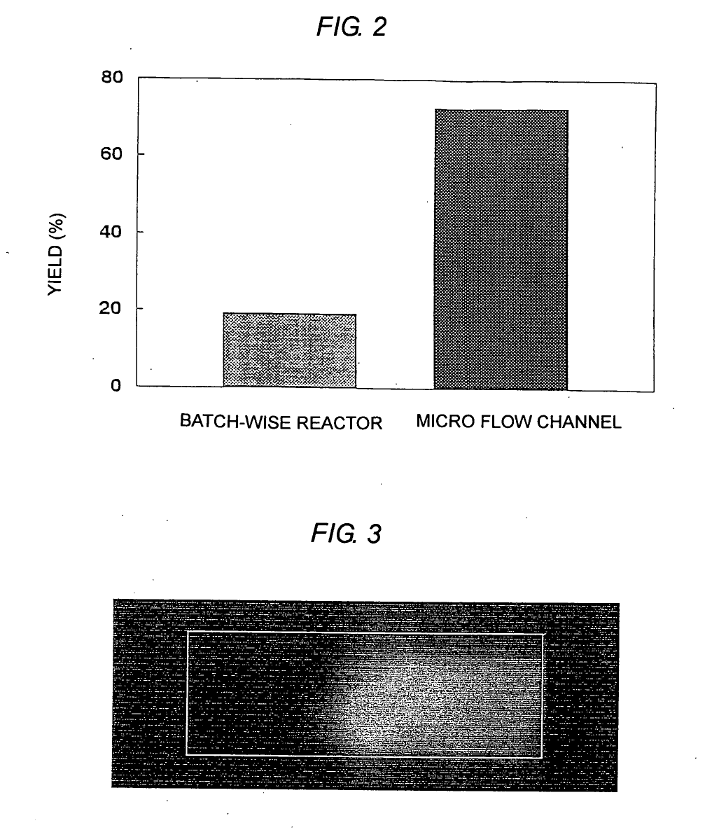

In FIG. 2, the yields of the above-mentioned enzymatic reaction were compared between the case by the batch-wise reactor and the case by the micro flow channel. A great improvement was noted in the yield by the use of the micro flow channel as compared with that in the batch-wise case.

It is understood from this result that a chemical reaction by utilizing a micro flow channel accomplishes a great improvement in the performance, as compared with a batch-wise manner as the major currents in the prior art methods.

### EXAMPLE 3

An aqueous solution containing 50 μmol/l of fluorescein and pure water were passed through a micro flow channel under formation of laminar flows and the state thereof was observed with a confocal laser scanning microscope.

FIG. 3 is a cross sectional view of the flow channel as observed with the confocal laser scanning microscope. While the aqueous solution containing fluorescein and pure water not containing the same are flowing to form laminar flows without mixing each with the other, an area recorded with a particularly higher brightness than therearound is found in the vicinity between both. This means presence of more fluorescein there to ensure a phenomenon of localization of the solute molecules in the vicinity of the center portion of the flow channel due to the specificity of the flow of a solution flowing through the micro flow channel.

### INDUSTRIAL UTILIZABILITY

According to the present invention, a change is brought about in the state of structure, orientation and others of the reactant molecules by the specificity of the flowing state of a solution flowing through a micro flow channel thereby enabling a high efficiency in conducting the chemical reaction. This is not limited to mere improvements in the reaction rate or yield but also is extended to the possibility to cause proceeding of a chemical reaction of which proceeding could hardly be expected by the prior art batch-wise method for a reason or so that the reaction sites are buried within a higher-order structure. According to the method of the present invention, moreover, it is possible to conduct not only syntheses of a substance or compound but also analysis and isolation of a specified substance.

1. A method for carrying out a reaction by utilizing a micro flow channel characterized in that, in carrying out a chemical reaction of two kinds or more of reactants capable of reacting each with the others, molecules of the reactants as carried by a fluid are introduced into a micro flow channel and the chemical reaction is carried out efficiently by utilizing interactions of the micro flow channel to cause changes in the molecular structure, molecular orientation or distribution of the molecules in the solution.

2. The method for carrying out a reaction by utilizing a micro flow channel described in claim 1 in which two kinds or more of the reactants are mixed together in advance and which is carried out under introducing of the fluid carrying the same.

3. The method for carrying out a reaction by utilizing a micro flow channel described in claim 1 in which fluids each individually carrying the molecules of two kinds or more of the reactants are concurrently passed through the micro flow channel so as to form laminar flows of both and to carry out the chemical reaction on the interface therebetween.

4. The method for carrying out a reaction by utilizing a micro flow channel described in claim 1 in which a fluid carrying molecules of one kind or more of the reactants is passed through the micro flow channel and the chemical reaction is carried out with molecules of a different reactant immobilized onto the wall surfaces of the flow channel.

5. The method for carrying out a reaction by utilizing a micro flow channel described in claim 1 which is carried out by utilizing the performance of the micro flow channel by which molecules of a compound having a long chain-formed or branched structure in an entangled condition by condensing in a solution are stretched into a straightly elongated condition.

6. The method for carrying out a reaction by utilizing a micro flow channel described in claim 1 which is carried out by utilizing the performance of the micro flow channel by which molecules of the compound dispersed in a random condition within the solution are brought into an oriented condition.

7. The method for carrying out a reaction by utilizing a micro flow channel described in claim 1 which is carried out by utilizing the performance of the micro flow channel by which, during passage of the solution through the micro flow channel, molecules of the reactants uniformly distributed in the solution become gathered to the core portion or to the vicinity of the wall surfaces of the flow channel.
